(19) United States
(12) Patent Application Publication
(10) Pub. No.: US 2016/0185268 A1
(43) Pub. Date: Jun. 30, 2016

(54) Truck Bed Slider

(71) Applicant: InstaCote, Inc., Erie, MI (US)

(72) Inventor: Thomas J. Nachtman, Temperance, MI (US)

(73) Assignee: InstaCote, Inc., Erie, MI (US)

(21) Appl. No.: 14/884,357

(22) Filed: Oct. 15, 2015

Related U.S. Application Data
(60) Provisional application No. 62/064,325, filed on Oct. 15, 2014.

(51) Int. Cl. B60P 1/00; B60R 9/06; B62D 33/02

(52) U.S. Cl. CPC B60P 1/006; B62D 33/02; B60R 9/06

(57) ABSTRACT

A truck bed slider includes a slide panel with a corrugated plastic base panel having a first surface and an opposed second surface. The base panel extends in a lateral direction and a longitudinal direction and has a handle. The slide panel includes a first coat applied to the first surface of the base panel and the first coat has a higher hardness than the material of the base panel. The slide panel is disposed in a truck bed so that the first coat is in contact with a bed surface of the truck bed.

### CROSS-REFERENCE TO RELATED APPLICATIONS

This application claims the benefit of U.S. Provisional Application No. 62/064,325, filed Oct. 15, 2014, the disclosure of which is incorporated herein by reference.

### BACKGROUND OF THE INVENTION

This invention relates in general to a device to improve access to the bed of a truck for storing and retrieving items and material.

### SUMMARY OF THE INVENTION

This invention relates to a truck bed slider. The truck bed slider includes a slide panel with a corrugated plastic base panel having a first surface and an opposed second surface. The base panel extends in a lateral direction and a longitudinal direction and has a handle. The slide panel includes a first coat applied to the first surface of the base panel and the first coat has a higher hardness than the material of the base panel. The slide panel is disposed in a truck bed so that the first coat is in contact with a bed surface of the truck bed.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a portion of a pickup truck.

FIG. 2 is a perspective view similar to that of FIG. 1, with a slide panel moved in a longitudinal direction relative to a truck bed of the pickup truck.

FIG. 3 is a cross-sectional view of a portion of the slide panel.

FIG. 4 is a specification sheet for a material suitable for use as a friction coat on the slide panel.

FIG. 5 is a specification sheet for a material suitable for use as a bump coat on the slide panel.

FIG. 6 is a cross-sectional view of an alternative slide panel.

### DETAILED DESCRIPTION OF THE PREFERRED EMBODIMENT

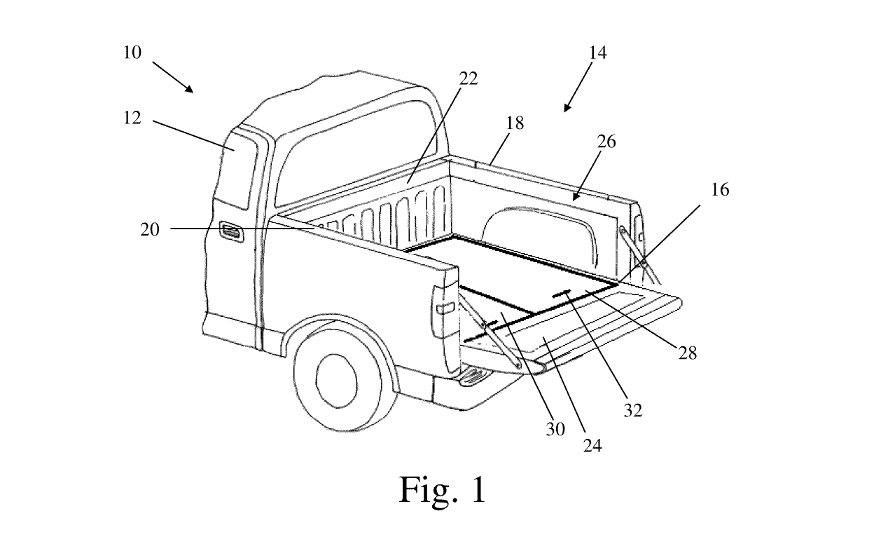

Referring now to the drawings, there is illustrated in FIG. 1 a perspective view of a portion of a pickup truck, indicated generally at 10. The pickup truck 10 includes a cab 12 and a truck bed, indicated generally at 14. The truck bed 14 includes a bed surface 16 that extends in a lateral direction between a pair of opposed side walls 18 and 20. The bed surface 16 also extends in a longitudinal direction between a cab wall 22 and a tailgate 24. The tailgate 24 is shown in a lowered position in FIG. 1, which provides easier access to the bed surface 16.

The pickup truck 10 also includes a bed slider, indicated generally at 26. The bed slider 26 is adapted to provide easier access to the truck bed 14 for the storage and removal of items therefrom. The illustrated bed slider 26 includes a pair of slide panels 28 and 30, but the bed slider 26 may comprise a single slide panel, or more than the two illustrated slide panels, if desired. The illustrated bed slider 26 extends the full length of the bed surface 16 in the longitudinal direction, and extends in the lateral direction between wheel well covers 32 (only one of which is visible in FIG. 1). However, the bed slider 26 may cover a different amount of the bed surface 16, if desired. The slide panels 28 and 30 are substantially identical, and only the slide panel 28 will be described in detail.

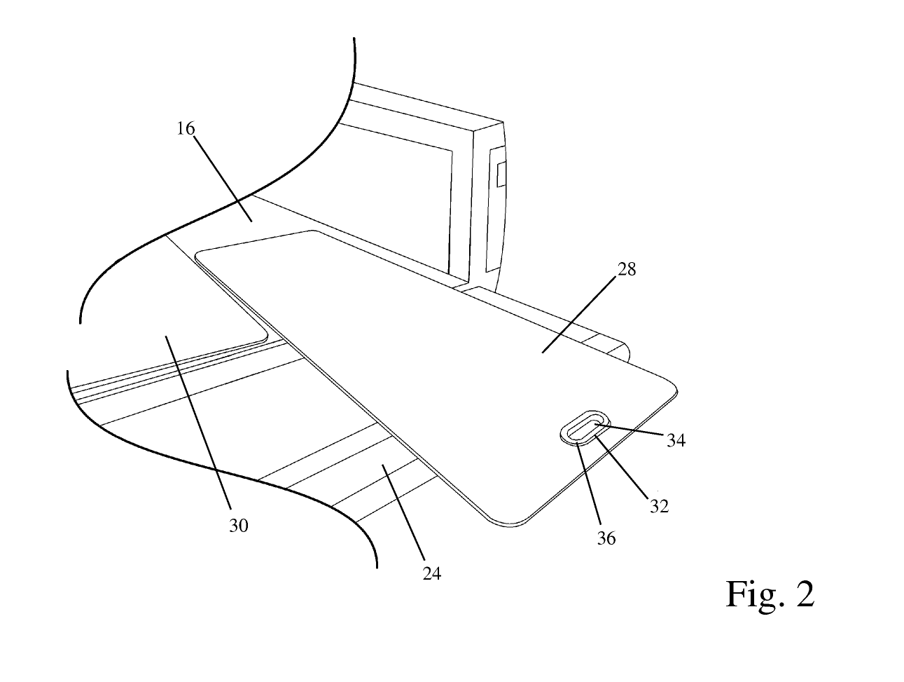

Referring to FIG. 2, a perspective view similar to that of FIG. 1 is shown, with the slide panel 28 moved in the longitudinal direction relative to the truck bed 14. As shown, the slide panel 28 has been moved far enough that it overhangs the outer end of the tailgate 24. It should be appreciated that when the slide panel 28 is in the position shown in FIG. 2, items may be placed on the slide panel 28 by an operator standing adjacent the tailgate 24. The slide panel 28 may then be pushed back toward the cab wall 22 to the position shown in FIG. 1. This allows the operator to access more usable space of the truck bed 14 while standing adjacent the tailgate 24. This allows the operator to easily make use of more of the truck bed 14 without having to reach over the side walls 18 and 20. This may be particularly advantageous if the pickup truck 10 includes a bed shell or a topper (not shown), which could limit access to the truck bed 14 over the sidewalls 18 and 20.

The illustrated slide panel 28 is generally rectangular in shape with rounded corners, but may have any desired shape. It should be appreciated that the slide panel 28 may have a particular shape to conform to or aesthetically contrast with details of the truck bed 14, if desired. The slide panel 28 includes a handle 32 for the operator to grasp when moving the slide panel 28 in the longitudinal direction. The illustrated handle 32 includes a through hole 34 that passes through the slide panel 28, and a plastic grommet 36 that fitted within the through hole 34. However, the handle 32 may have any other desired configuration. The illustrated handle 32 is located in the center of the slide panel 28 in the lateral direction, and generally near a rear end of the slide panel 28 in the longitudinal direction.

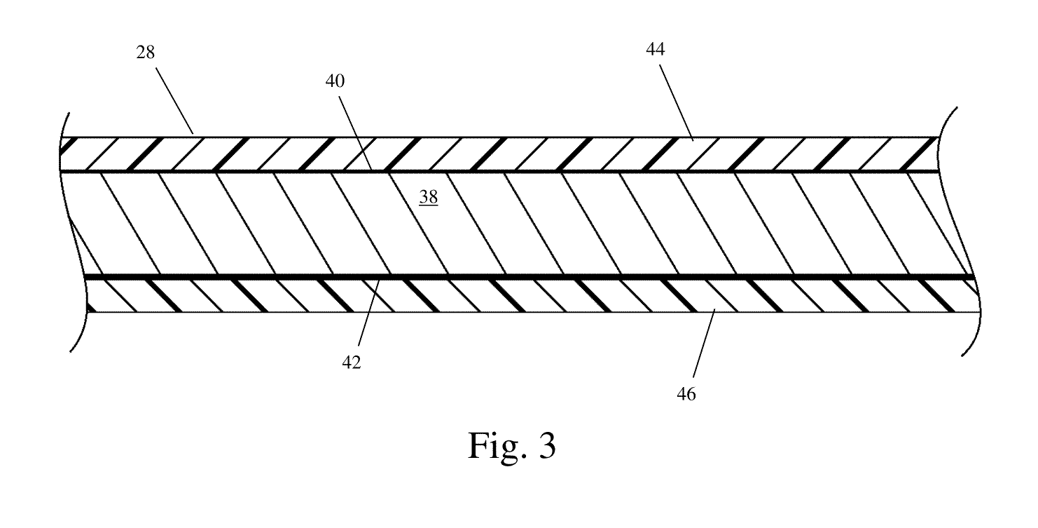

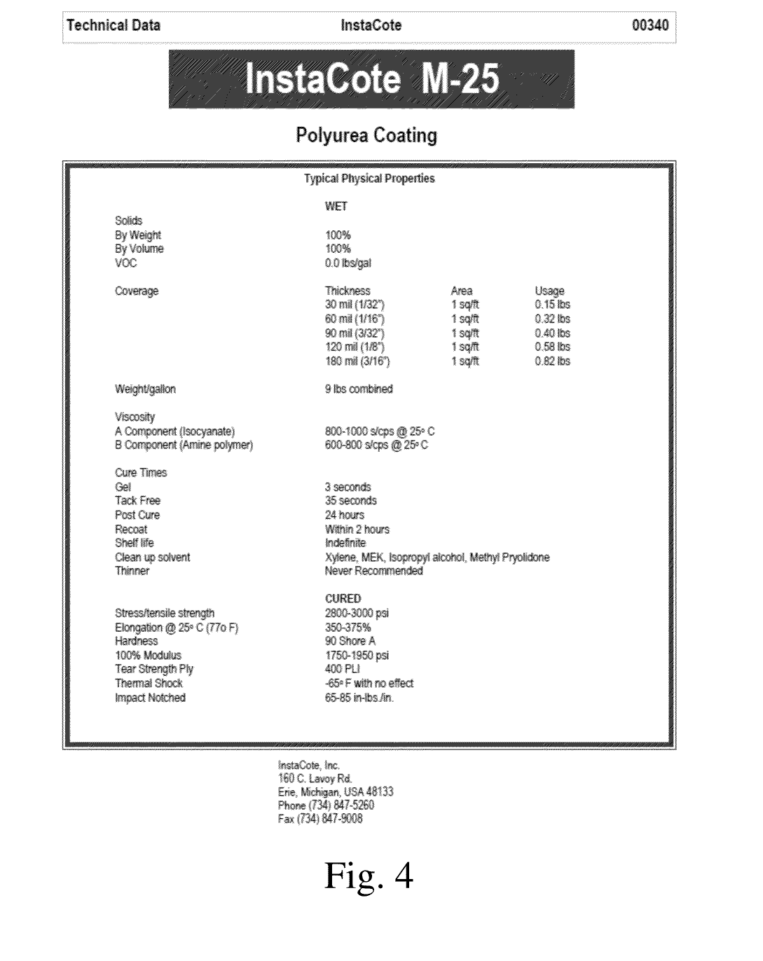

Referring to FIG. 3, a cross-sectional view of a portion of the slide panel 28 is shown. The slide panel 28 includes a base panel 38. The illustrated base panel 38 is a piece of corrugated plastic that has a thickness of one-eighth an inch, but the base panel 38 may be made of any other desired material having any desired thickness. The base panel 38 is generally planar, and has a first surface 40 and an opposed second surface 42. The slide panel 28 includes a first coat 44 applied to the first surface 40 of the base panel 38. The illustrated first coat 44 is a polyurea friction coat. The polyurea friction coat is a spray-applied material that cures to have a lower hardness than the base panel 38. In the illustrated embodiment, the friction coat is INSTACOTE IC-800-2 (a specification sheet is shown in FIG. 4) applied to be approximately 30-50 thick. However, other desired materials or thicknesses may be used.

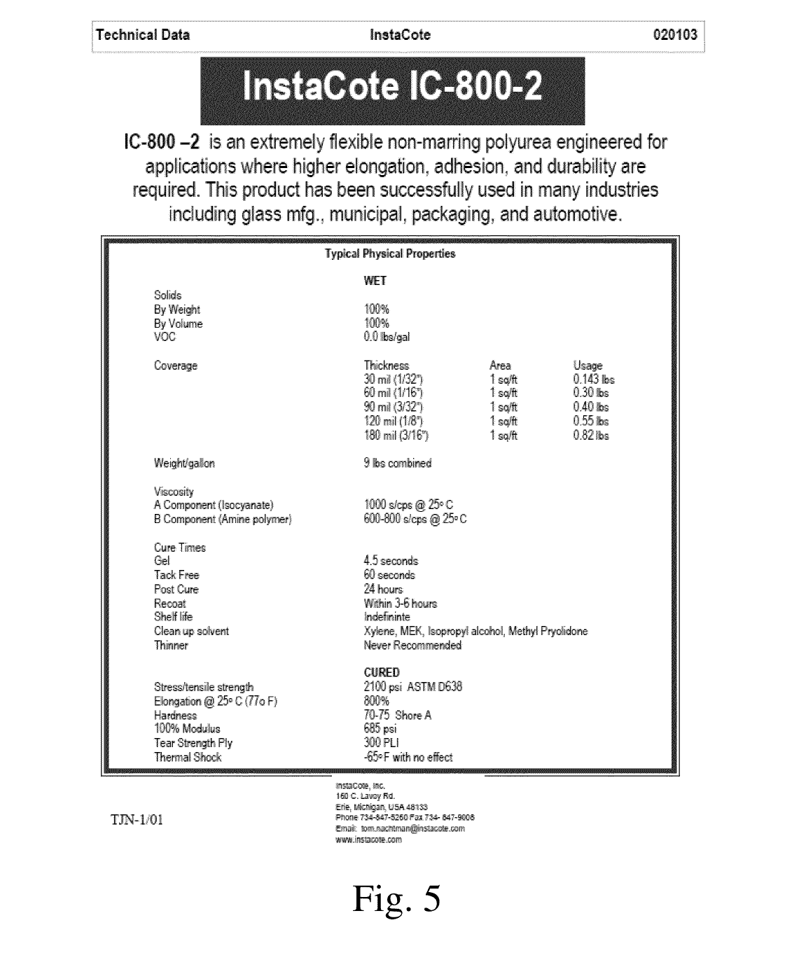

The illustrated slide panel 28 also includes an optional second coat 46 applied to the second surface 42 of the base panel 38. The illustrated second coat 46 is a polyurea bump coat. The polyurea bump coat is a spray-applied material that cures to have a higher tensile strength and a higher hardness than the material comprising the base panel 38. In the illustrated embodiment, the bump coat is INSTACOTE M-25 (a specification sheet for which is shown in FIG. 5) applied to be approximately 30-50 thick. However, other desired materials or thicknesses may be used. The illustrated second coat 46 increases the stiffness of the slide panel 28 as compared to the base panel 38.

In use, the illustrated slide panel 28 is placed in the truck bed 14 as shown in FIG. 1 with the base panel 38 oriented so that the first surface 40 faces upwards, away from the bed surface 16, and so that the second surface 42 faces downward, toward the bed surface 16. In this position, the second coat 46 of the slide panel 28 is in contact with the bed surface 16. As previous described, the illustrated second coat 46 is a bump coat, and due to its texture it reduces the surface area of the slide panel 28 that is in contact with the bed surface 16, as compared to the base panel 38 without the second coat 46. Additionally, as previously described, the second coat 46 has a higher hardness than the base panel 38. As a result, the slide panel 28 is easier for the operator to slide over the bed surface 16 than the base panel 38 would be without the second coat 46. Additionally, when the operator places items on the slide panel 28, those items are placed on the first coat 44. As previously described, the first coat 44 has a lower hardness than the base panel 38. Therefore, the first coat 44 of the slide panel 28 has a higher frictional coefficient than the base panel 38 would have without the first coat 44. Therefore, the items placed on the slide panel 28 by the operator are less likely to move relative to the slide panel 28 when either the slide panel 28 or the pickup truck 10 is moved.

It should be appreciated that the first coat 44 and the second coat 46 may be made from different materials that those previously described, if desired. Either the first coat 44 or the second coat 46 may have an increased or decreased hardness, for example. Additionally, either the first coat 44 or the second coat 46 may be made of a material other than polyurea, if desired.

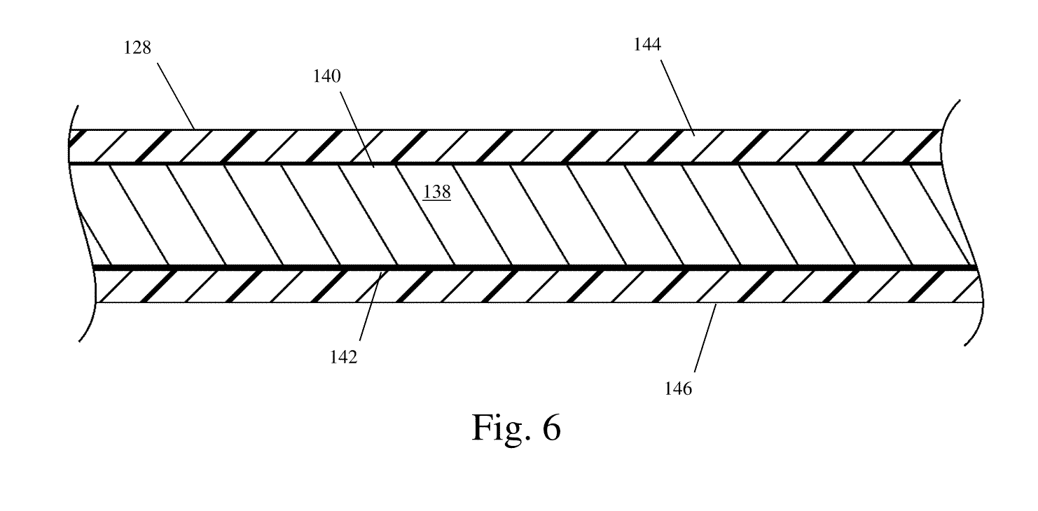

In an alternative slide panel 128, shown in FIG. 6, a base panel 138 includes a second coat 146 is made of the same material as a first coat 144. In this alternative embodiment, the slide panel 128 has the polyurea bump coat on each surface. This allows the operator to place the alternative slide panel 128 in the truck bed 14 with either surface in contact with the bed surface 16 without negatively affecting the operator's ability to slide the alternative slide panel 128 on the bed surface 16. This is advantageous in that, for example, the operator may flip the alternative slide panel 128 over in the event that it is stained in order to conceal the stain and continue to use the alternative slide panel 128.

Although the preferred embodiments have been described as being located in the truck bed 14 of the pickup truck 10, it should be appreciated that the bed slide 26 may be used in any other desired location.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A truck bed slider comprising:
a slide panel including a corrugated plastic base panel having a first surface and an opposed second surface, the base panel extending in a lateral direction and a longitudinal direction and having a handle, the slide panel including a first coat applied to the first surface of the base panel, the first coat having a lower hardness than the material of the base panel;
the slide panel disposed in a truck bed so that the second surface of the base panel is in contact with a bed surface of the truck bed.

2. The truck bed slider of claim 1, further comprising:
a second coat applied to the second surface of the base panel, the second coat having a higher hardness than the material of the base panel.

3. The truck bed slider of claim 2, wherein the second coat is made of a material that has a higher tensile strength than the material of the base panel.

4. A truck bed slider comprising:
a slide panel including a corrugated plastic base panel having a first surface and an opposed second surface, the base panel extending in a lateral direction and a longitudinal direction and having a handle comprising a through hole located in the center of the base panel in the lateral direction and nearer one side of the base panel in the longitudinal direction;
the slide panel including a first coat applied to the first surface of the base panel, the first coat having a higher hardness than the material of the base panel;
the slide panel including a second coat applied to the second surface of the base panel, the second coat having a higher hardness than the material of the base panel; and
the slide panel disposed in a truck bed so that the second coat is in contact with a bed surface of the truck bed.

5. The truck bed slider of claim 4, wherein the first coat is made of a polyurea material and the second coat is made of a poly urea material.

6. The truck bed slider of claim 5, wherein the second coat is made of the same material as the first coat.

7. A truck bed slider comprising:
a slide panel including a corrugated plastic base panel having a first surface and an opposed second surface, the base panel extending in a lateral direction and a longitudinal direction and having a handle comprising a through hole located in the center of the base panel in the lateral direction and nearer one side of the base panel in the longitudinal direction;
the slide panel including a first coat applied to the first surface of the base panel, the first coat having a lower hardness than the material of the base panel;
the slide panel including a second coat applied to the second surface of the base panel, the second coat having a higher hardness than the material of the base panel; and
the slide panel disposed in a truck bed so that the second coat is in contact with a bed surface of the truck bed.

8. The truck bed slider of claim 7, wherein the first coat is made of a polyurea material and the second coat is made of a polyurea material.
